(19) United States
(12) Patent Application Publication
(10) Pub. No.: US 2024/0195272 A1
(43) Pub. Date: Jun. 13, 2024

(54) STRUCTURE AND MANUFACTURING METHOD OF AXIAL FLUX ELECTRIC MACHINE STATOR

(71) Applicants: RENAULT S.A.S., Boulogne Billancourt (FR); WHYLOT, Cambes (FR)

(72) Inventor: Jere KOLEHMAINEN, Saint-Aubin-lès-Elbeuf (FR)

(21) Appl. No.: 18/556,966

(22) PCT Filed: Apr. 28, 2022
(86) PCT No.: PCT/EP2022/061356

§ 371 Date: Oct. 24, 2023

(30) Foreign Application Priority Data
Apr. 28, 2021 (FR) 2104433

(51) Int. Cl. H02K 15/02; H02K 1/14

(52) U.S. Cl. CPC H02K 15/022; H02K 1/146

(57) ABSTRACT

Disclosed is a method for manufacturing a stator for an axial-flux electric machine, the stator including a stator body, a plurality of teeth, and at least one coil formed of an electrically conductive wire, each tooth being formed of a first part and a second part, the method including steps of: obtaining a support part in which the teeth are each positioned in a precise attitude; forming an envelope of electrically insulating material intended to surround the second part of each tooth; winding the electrically conductive wire around the envelope; and fixing an end of the second part of each tooth to a face of the stator body.

### CROSS-REFERENCE TO RELATED APPLICATIONS

This application is the US national stage of PCT/EP2022/061356, filed Apr. 28, 2022 and designating the United States, which claims the priority of FR FR2104433, filed Apr. 28, 2021. The entire contents of each foregoing application are incorporated herein by reference.

### BACKGROUND OF THE INVENTION

### Field of the Invention

The present invention generally relates to axial-flux electric machines.

It relates more specifically to a method for manufacturing a stator for an axial-flux electric machine.

The invention also relates to a stator obtained by such a manufacturing method, as well as an engine and an automotive vehicle comprising such a stator.

### Description of the Related Art

A conventional stator for an axial-flux electric machine comprising a body with a mainly annular base and teeth distributed circumferentially over one of the end faces of the base. A stator also comprises coils of conductive wire arranged around the teeth. Under the effect of electric currents, the coils generate magnetic fields enabling the stator to move the rotor.

Conventionally, the body of the stator is made by winding a metal sheet about a longitudinal axis. This winding of a metal sheet makes it possible to limit the Foucault currents crossing the stator, when the latter is in operation and, consequently, to reduce the energy losses by heating.

Following the manufacturing of the stator body in this way, three methods for performing windings of conductive wire around the teeth are known, in order to form the coils of the stator.

According to the first method, the teeth have a mainly parallelepiped shape, which h facilitates the winding of the conductive wire around each tooth. This configuration facilitates the industrial manufacturing of the stator, since the space between the teeth is sufficiently large to wind, without difficulty, the conductive wire. However, the use of such a tooth shape involves a degradation of the electric properties of the electric machine.

According to a second manufacturing method, the teeth expand at their free ends, which improves the circulation of the magnetic fields. In this configuration, the conductive wire forming the coil must be introduced between the teeth, in a very narrow slot. This step is not easy to implement in an industrial process.

The third known method aims to improve this second method. For this, after the winding of the metal sheet forming the stator body and the teeth, the teeth are cut from the stator body. The coils are then formed, individually, around each of the teeth. The teeth are finally replaced on the stator body. In a variant, the teeth are each made separately by stacking cut magnetic sheets, coiled then assembled on a stator body.

However, such a method is not easy to implement industrially, in particular as the positioning of the teeth on the stator body must be done precisely, in order to guarantee the magnetic properties of the assembly. In addition, such a configuration alters the rigidity and the mechanical resistance of the stator.

### SUMMARY OF THE INVENTION

The present invention proposes to improve the method for manufacturing the stator, in order to form a robust stator in which the teeth are arranged so as to optimise the magnetic and electric properties of the stator.

More specifically, a method for manufacturing a stator for an axial-flux electric machine is proposed according to the invention, said stator comprising a stator body, a plurality of teeth and at least one coil formed of an electrically conductive wire, each tooth being formed of a first upper part and a second lower part, the method comprising steps of:
obtaining a support part in which teeth are each positioned in a precise attitude,
forming an envelope of electrically insulating material, intended to surround the second part of each tooth,
winding the electrically conductive wire around said envelope, and
fixing an end of the second part of each tooth to a face of the stator body.

Thus, thanks to the invention, a support part is formed in order to position, precisely, the teeth in orientation and in spatial position. The assembly formed by the support part, the teeth and the coils of electrically conductive wire is then fixed to the stator body, thus enabling a precise alignment of the teeth. This arrangement thus enables an optimisation of the magnetic and electric properties of the stator.

In addition, as the support part and the teeth are assembled, then fixed to the stator body of one single block, this makes it possible to guarantee a mechanical resistance of the stator obtained.

Other advantageous and non-limiting features of the method for manufacturing a stator according to the invention, taken individually or according to any technically possible combinations, are as follows:
it is also provided, prior to the formation of the support part, a step of positioning the teeth in the preformed notches of a mold for manufacturing the support part;
it is also provided, prior to the winding of the electrically conductive wire around said envelope, a step of extracting the teeth from the mould;
the support part and said envelope are formed of one single part by molding;
the support part having a plurality of openings, a step of putting each tooth in place in a corresponding opening of the support part is provided, each opening being shaped to receive each tooth in said precise attitude;
each tooth is fixed by bonding to the support part;
the support part and said envelope are formed of polymer material; and
the fixing of the end of the second part of each tooth on the face of the stator body is done by bonding.

The invention also relates to a stator obtained by the manufacturing method described above.

The invention also relates to a stator casing comprising a stator such as defined above and a base receiving the stator, said base comprising a bottom wall and side walls so as to form a cooling chamber. A polymer material is, for example, overmolded around the stator in the cooling chamber.

The invention also relates to an engine comprising a rotor and a stator such as defined above, as well as an automotive vehicle comprising such an engine.

Naturally, the different features, variants and embodiments of the invention can be associated with one another according to various combinations insofar as they are not incompatible with or exclusive from one another.

### BRIEF DESCRIPTION OF THE DRAWINGS

The description below regarding the accompanying drawings, given as non-limiting examples, will make it understood what the invention consists of, and how it can be achieved.

In the accompanying drawings:

FIG. 1 represents a schematic, perspective, front view of a stator according to the invention;

FIG. 2 represents a schematic, perspective, rear view of the stator of FIG. 1;

FIG. 3 represents, in the form of a flowchart, a first example of a method for manufacturing a stator according to the invention,

FIG. 4 schematically represents a cross-sectional view of the product obtained during step E2 of a first example of the method for manufacturing the stator,

FIG. 5 schematically represents a cross-sectional view of the product obtained during step E4 of the first example of the method for manufacturing the stator,

FIG. 6 schematically represents a cross-sectional view of the product obtained during step E8 of the first example of the method for manufacturing the stator,

FIG. 7 schematically represents a cross-sectional view of the product obtained during step E10 of the first example of the method for manufacturing the stator,

FIG. 8 represents, in the form of a flowchart, a second example of a method for manufacturing a stator according to the invention,

FIG. 9 schematically represents a cross-sectional view of the product obtained during step E22 of a second example of the method for manufacturing the stator,

FIG. 10 schematically represents a cross-sectional view of the product obtained during step E24 of the second example of the method for manufacturing the stator,

FIG. 11 schematically represents a cross-sectional view of the product obtained during step E26 of the second example of the method for manufacturing the stator,

FIG. 12 schematically represents a cross-sectional view of the product obtained during step E28 of the second example of the method for manufacturing the stator,

FIG. 13 schematically represents an automotive vehicle equipped with an engine comprising a stator according to the invention,

FIG. 14 represents a schematic, perspective view of a first example of cooperation between a tooth and the upper face of a stator body,

FIG. 15 represents a schematic, perspective view of a second example of cooperation between a tooth and the upper face of the stator body, and

FIG. 16 schematically represents a cross-sectional view of a stator casing comprising a stator according to the invention.

### DETAILED DESCRIPTION

Preliminarily, it will be noted that identical or similar elements of the different embodiments of the invention represented in the different figures will be, insofar as possible, referenced by the same reference signs and will not be described each time.

Below in the description, the terms “conductive” and “insulating” will be used to define the electric or dielectric properties of the respectively electrically conductive and electrically insulating materials.

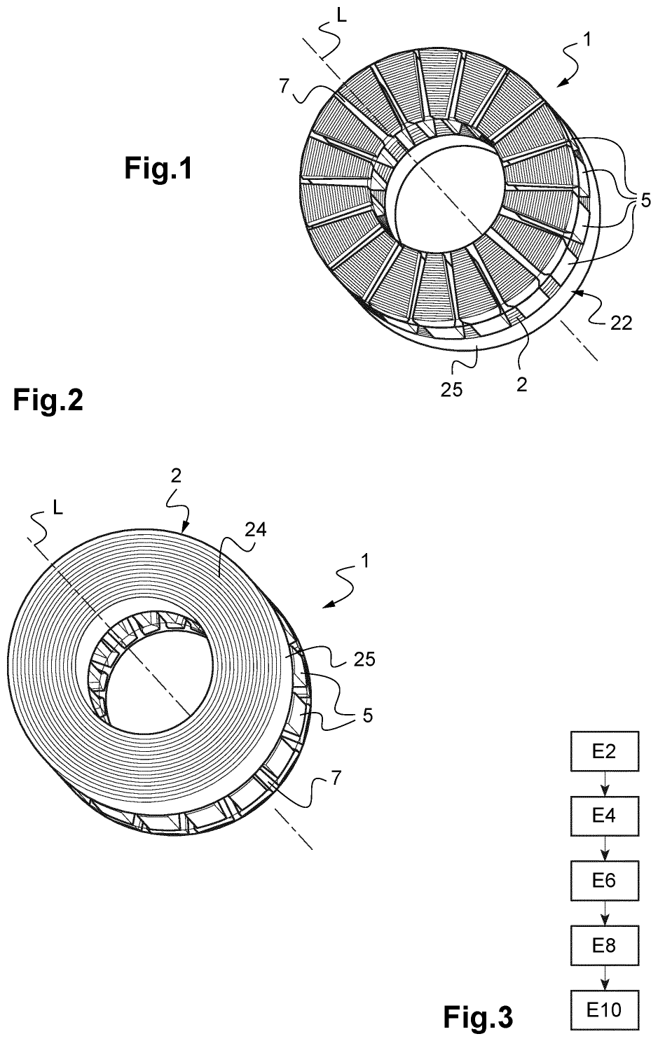

In FIGS. 1 and 2, a stator 1 for an axial-flow electric machine has been represented schematically, respectively as a front view and as a rear view.

The stator 1 comprises a stator 1 body 2, a plurality of teeth 5, a support part 7 of the plurality of teeth 2 and at least one coil 9 formed of an electrically conductive wire (which cannot be seen in FIGS. 1 and 2).

As FIGS. 1 and 2 show, the stator 1 body 2 has a flattened ring shape, of height less than its diameter. The stator 1 body 2 has a flat upper face 22, a flat lower face 24, an external peripheral face 25 and an internal peripheral face, both cylindrical of revolution.

The body 2 of the stator 1 is made of magnetic material. It is, for example, made by a stacking of steel sheets of a thickness less than or equal to half a millimetre. These sheet plates are, in this case, curved and wound in a spiral about an axis L orthogonal to the plane of the upper 22 and lower 24 faces. They extend over the entire height of the stator 1 body 2. Thus, the losses in the stator due to the Foucault currents are limited.

The stator 1 also comprises the plurality of teeth 5. This plurality of teeth 5 is regularly distributed over the upper face 22 of the stator 1 body 2 all about the axis L (FIGS. 1 and 2). As can be seen in FIG. 1, each tooth 5 mainly has a straight prism shape, of trapezoidal cross-section (in a plane parallel to the upper face 22 of the stator 1 body 2). The side faces facing the neighbouring teeth 5 are, in this case, parallel to one another.

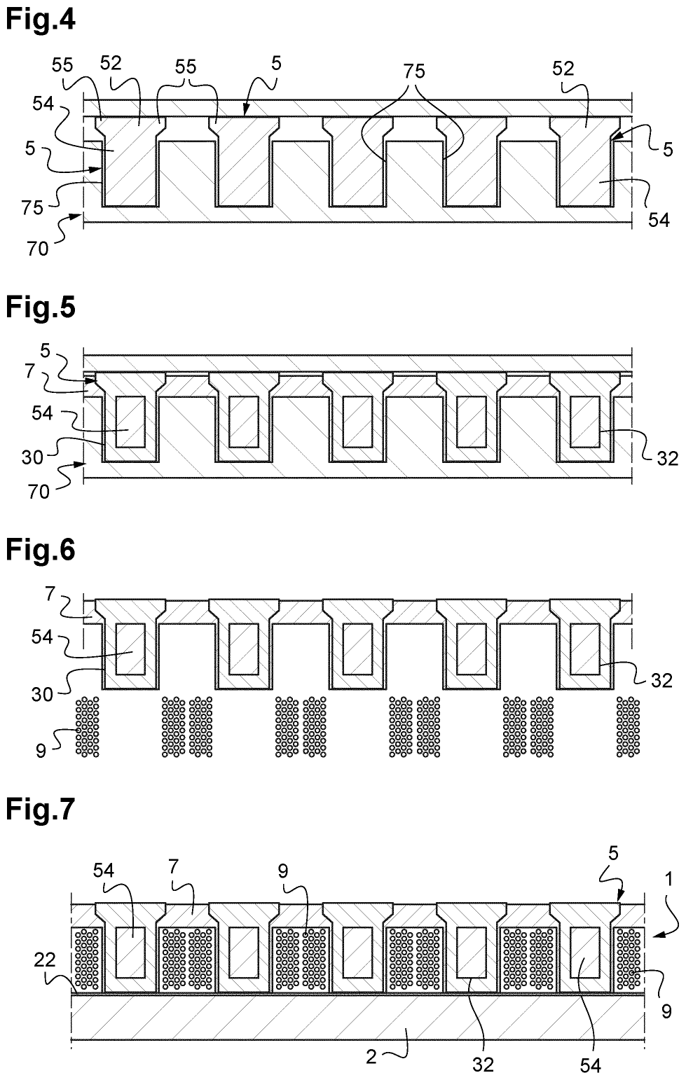

Each tooth 5 has, in this case, a first part 52, or distal part 52 below, and a second part 54, or proximal part 54 below in this description (FIG. 4). As, for example, FIG. 7 shows, the proximal part 54 of each tooth 5 is transferred onto the upper face 22 of the stator 1 body 2. In practice, each end of the proximal part 54 of each tooth 5 is fixed by bonding onto the upper face 22 of the stator 1 body 2.

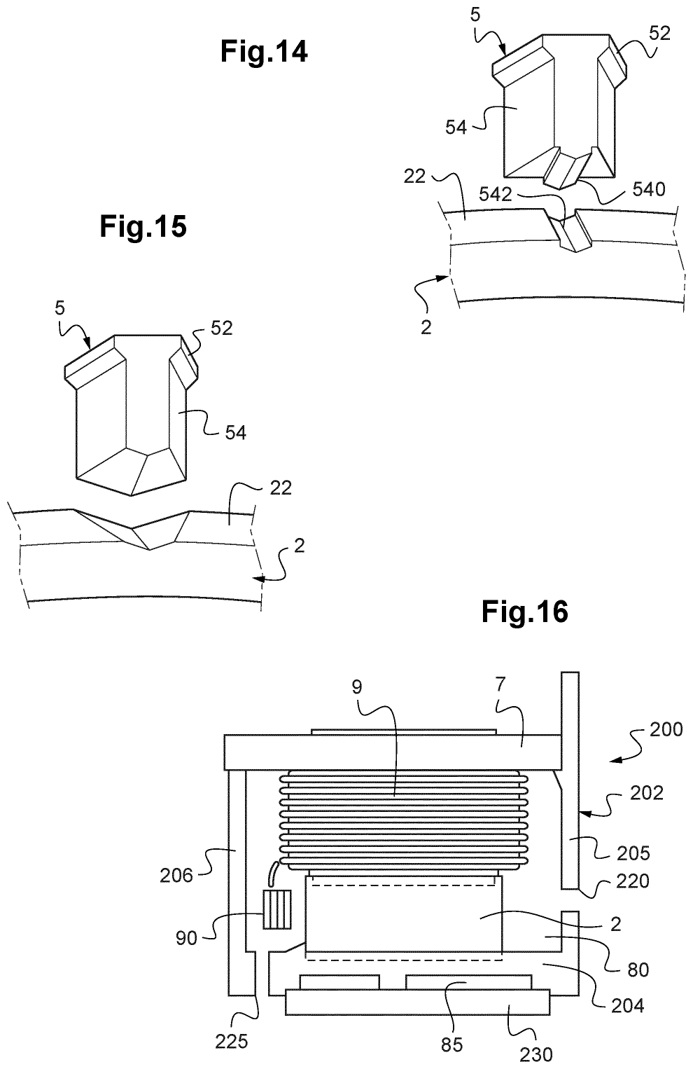

In a variant, as it is represented in FIGS. 14 and 15, the cooperation between the proximal part 54 of each tooth 5 and the upper face 22 of the stator 1 body 2 can also be achieved by interlocking each tooth 5 onto the upper face 22 of the stator 1 body 2. More specifically, the end of the proximal part 54 of each tooth 5 has a complementary shape of a part of the upper face 22 of the stator 1 body 2.

For example, in the case of FIG. 14, the end of the proximal part 54 of each tooth 5 has a projecting part 540 intended to cooperate, for example by interlocking, with a groove 542, formed on the upper face 22 of the stator 1 body 2, and having a complementary shape of the projecting part 540. This groove can have a V-shaped dihedral cross-section (FIG. 15) or a U-shaped cross-section, the bottom of which has a V-shape (FIG. 14). This shape has the advantage of improving the passage of the magnetic flux between the base of the tooth and the part of the cylinder head located between two teeth, in particular when the tooth is made of a sheet with grains oriented magnetically axially, and when the cylinder head is made of a sheet with grains orientally magnetically angularly, for like example in document WO2020/078667.

Also, still in a variant, the cooperation between the proximal part 54 of each tooth 5 and the upper face 22 of the stator 1 body 2, can be achieved by a combination of the bonding and of the interlocking of each tooth 5 on the upper face 22 of the stator 1 body 2 described above.

Moreover, the distal part 52 of each tooth 5 has, at least on one side, a projecting ridge 55. In this case, two projecting ridges 55 are formed on either side of each tooth 5, in the extension of the end of the distal part 52 of each tooth 5. As can be seen in FIG. 1, the projecting ridge 55 of a tooth 5 faces the projecting ridge 55 of the adjacent tooth 5. These projecting ridges 55 are particularly advantageous, as they reduce the available space between the teeth 5, which makes it possible to decrease the variations in magnetic fields at the stator 1 and lessens the associated power losses. This also makes it possible to reduce the magnetic resistance of the gap between the stator 1 and an associated rotor.

Advantageously, in this case, the teeth 5 are positioned in a support part 7. This support part 7 also has, in this case, a flattened ring shape (FIGS. 1 and 2). The support part 7 is shaped to support each tooth 5 in a precise attitude, at least at the time of assembling these teeth 5 on the stator 1 body 2.

In this description, in this case, “precise attitude” means a positioning of each tooth 5 relative to the other teeth in a predefined, stable, spatial position, and according to a predetermined orientation. The use of this support part 7 therefore enables a precise arrangement of the teeth 5, against one another, on the stator 1 body 2. This makes it possible to guarantee the magnetic properties of the assembly of the stator 1 by limiting the losses due to an incorrect alignment and an incorrect positioning of the teeth 5 against one another.

The support part 7 is preferably designed of an electrically insulating material. It is, for example, molded of plastic material.

As, for example, FIGS. 6 and 7 show, each tooth 5 is provided to be surrounded by an envelope 30 formed of an electrically insulating material. For example, this envelope is molded of polymer material.

According to a first embodiment of the invention (FIGS. 3 to 7), the support part 7 and the envelope 30 are formed of one single part by molding.

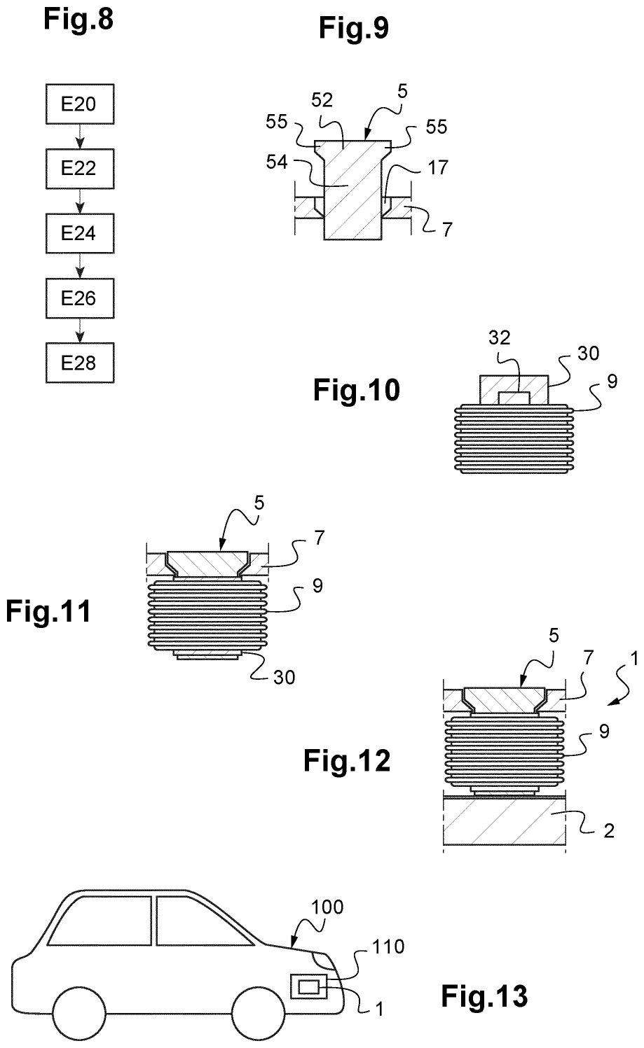

According to a second embodiment (FIGS. 8 to 12), the support part 7 and the envelope 30 are formed of two distinct parts.

As can be seen, for example, in FIG. 6, each envelope 30 is intended to surround the proximal part 54 of the tooth 5 in question.

The stator 1 finally comprises coils 9 formed of electrically conductive wires. As FIGS. 7, 11 and 12 show, an electrically conductive wire is wound around each envelope 30 formed around the teeth 5 so as to form the coils 9. The electrically conductive wire is, for example, a copper wire. The coils are, in practice, electrically connected to an electric connection unit 90 (FIG. 16).

The stator 1 according to the invention is intended to be used in an engine 110 (also comprising a rotor) of an automotive vehicle 100 (FIG. 13).

FIG. 16 represents an example of a stator casing 200, in which the stator 1 is introduced. The stator casing 200 comprises a base 202 receiving the stator 1. This base 202 has, in this case, a bottom wall 204 and two side walls 205, 206 extending from the bottom wall 204.

The lower face of the stator body 2 is fixed to the bottom wall 204 of the stator casing 200, for example, by bonding.

The support part 7 is positioned in the base 202 so as to form a closed internal chamber 80. In other words, the walls of the internal chamber 80 are formed by the bottom wall 204 of the base 202, by the side walls 205, 206 of the base 202 and the support part 7 of the stator 1. Seals (which cannot be seen in the figures) positioned between the support part 7 and the side walls 205, 206 of the base 202 make it possible to ensure the sealing of the internal chamber 80.

Thus, once the stator 1 is fixed onto the bottom wall 204 of the stator casing 200, the internal chamber 80 can advantageously form a cooling chamber. For this purpose, as it is represented in FIG. 16, the base 202 comprises inlet 220 and outlet 225 openings enabling the circulation of a cooling liquid. This cooling liquid is, for example, a dielectric cooling liquid such as oil. Advantageously in this case, the cooling liquid can thus circulate between the coils 9 surrounding the teeth 5 and thus enable the cooling of the stator 1 without including complex channel systems in the body of each tooth.

The stator casing 200 also comprises a bottom element 230 positioned facing the bottom wall 204 of the base 202, outside of the base 202. This bottom element 230 thus makes it possible to form a closed external chamber 85. Seals (which cannot be seen in the figures) positioned between the bottom element 230 and the bottom wall 204 of the base 202 make it possible to guarantee the sealing of the external chamber 85.

Advantageously, the external chamber 85 can form another cooling chamber of the stator casing 200. For this purpose, openings (not represented) for supplying and discharging a cooling liquid are provided between the bottom element 230 and the bottom wall 204 of the base 202. The cooling liquid is, in this case, water or oil.

Finally, the cooling of the stator casing 200 can be done in several ways, thanks to the arrangements introduced:
cooling by circulation of a liquid inside the internal chamber 80, or
cooling by circulation of a liquid inside the external chamber 85, or also
cooling by circulation of a liquid inside the internal chamber 80 and another liquid inside the external chamber 85.

In a variant in use of the circulation of a liquid, the internal chamber 80 can be filled with a polymer material to enable the cooling. The polymer material is, for example, overmolded around the stator (1) in the internal chamber 80 formed in the stator casing 200.

FIG. 3 represents, in the form of a flowchart, a first example of a method for manufacturing the stator 1.

Prior to the implementation of this method, it is assumed that the teeth 5 and the stator 1 body 2 have been formed moreover (the manufacturing of these elements is not considered as constituting the core of the invention, and is therefore not described in detail below).

As FIG. 3 shows, the method starts in step E2. During this step, the teeth 5 are positioned in preformed notches 75 of a mold 70 for manufacturing the support part 7 (FIG. 4).

As FIG. 4 shows, only the proximal part 54 of each tooth 5 is, in this case, transferred into the corresponding notch 75. In this case, each notch 75 has dimensions slightly greater than those of the proximal part 54 of the tooth 5 in question, thus forming a small clearance between the side faces of each tooth 5 and the side walls of the notch 75 in question.

The manufacturing method continues in step E4. During this step, the support part 7 and the envelope 30 are formed. They are, in this first example, formed of one single part by molding. In practice, the polymer material is cast in the manufacturing mold 70.

As FIG. 5 shows, the polymer material is introduced between the side faces of the teeth 5 and the side walls of the notches 75, thus forming the envelope 30 around the proximal part 54 of each tooth 5. In this case, the polymer material does not fully cover the proximal part 54 of each tooth 5.

In other words, the insulating envelope 30 has openings 32. These openings 32 for example, come from the positioning means which hold the teeth 5 in position during the manufacturing method (for example, during the introduction of the polymer material).

As FIG. 5 also shows, the polymer material extending between each of the distal parts 52 of each tooth 5 forms the support part 7. The support part 7 is thus presented in the form of a plate connecting the projecting ridges 55 of the teeth 5 to one another.

Finally, at the end of step E4, the support part 7 is obtained, in which the teeth 5 are each positioned in a precise attitude and the envelope 30, formed of electrically insulating material and surrounding each proximal part 54 of each tooth 5.

During step E6, the assembly formed by the support part 7, the teeth 5 and the envelope 30 is extracted from the manufacturing mold 70.

The method thus continues in step E8 (FIG. 6), during which the electrically conductive wire is wound around each envelope 30 formed in step E4, so as to obtain the coils 9. In practice, the electrically conductive wire is wound, for example, from one single piece, around the envelope 30.

The method finally ends by step E10, during which the assembly formed by the support part 7, the teeth 5, the envelope 30 and the coils 9 is fixed on the stator 1 body 2. More specifically, each free end of the proximal parts 54 of each tooth 5 is transferred onto the upper face 22 of the stator 1 body 2. The fixing is, in this case, done by bonding. In a variant, as described above and represented in FIGS. 14 and 15, the fixing can be done by interlocking of the proximal part 54 of each tooth 5 on the upper face 22 of the stator 1 body 2 or by any other suitable method.

At the end of step E10, the stator 1 is assembled and formed (FIG. 7).

FIG. 8 represents, in the form of a flowchart, a second example of a method for manufacturing the stator 1.

Also in this case, prior to the implementation of this method, it is assumed that the teeth 5 and the stator 1 body 2 have moreover been formed.

As FIG. 8 shows, the method starts in step E20 of obtaining the support part 7. According to this second embodiment, the support plate 7 is made independently of teeth 5. It is, for example, formed, by molding in polymer material, from another manufacturing mold (not represented). This other manufacturing mold, enables in particular the formation of openings 17 (FIG. 9), each intended to receive a tooth 5. The support part 7 obtained therefore comprises as many openings 17 as there are teeth 5. These openings 17 are shaped to enable the positioning of each of the teeth 5 at a precise attitude such as defined above. In particular, as FIG. 9 shows, the opening 17 has a complementary shape of the distal part 52 of the tooth 5, thus making it possible to support this distal part 52.

The method then continues in step E22. During this step, each tooth 5 is put in place in the corresponding opening 17 of the support part 7 (FIG. 9). More specifically, the edges of each opening 17 are intended to cooperate with the distal part 52 of each tooth 5, and in particular with the projecting ridges 55 of each tooth 5.

In practice, each tooth 5 (via its distal part 52) is fixed by bonding to the edges of the corresponding opening 17 of the support part 7. In a variant, this fixing can be achieved by interlocking or any other suitable cooperation means.

At the same time as putting the teeth 5 into place on the support part 7, the manufacturing method comprises step E24, during which the envelope 30 is formed of electrically insulating material.

According to this second embodiment, the envelope 30 is, in this case, formed separately from the support part 7. The envelope 30 is, for example, formed by way of a specific manufacturing mold (not represented) by molding in polymer material. The envelope 30 is also, in this case, shaped to surround the proximal part 54 of each tooth 5.

As in the first embodiment described above, the envelope 30 can have (or not) openings 32 in its side parts.

Once the envelope 30 is formed, the electrically conductive wire is wound around it, in order to form the coil 9 (FIG. 10).

Finally, at the end of steps E22 and E24, on the one hand, the support part 7 is formed, in which the teeth 5 are positioned in a precise attitude and, on the other hand, the envelope 30 is formed (of electrically insulating material) wound from the electrically conductive wire.

Step E26 thus enables the positioning of the envelope 30 provided with the electrically conductive wire on the proximal part 54 of each tooth 5 (FIG. 11).

In practice, the assembly of the envelope 30 provided with the electrically conductive wire on the proximal part 54 of each tooth 5 is, for example, done by snap-fitting or by bonding.

The method finally ends by step E28 (similar to step E10 described above). During this step, the assembly formed by the support part 7, the teeth 5, the envelope 30 and the coils 9 is fixed on the stator 1 body 2.

At the end of step E28, the stator 1 is assembled and formed (a part of which is represented in FIG. 12).

In a variant, it could have been provided that the envelope is simply formed of an insulating sheet of paper.

Finalizing steps, like for example, coating the assembly formed by the different elements of the stator, can be provided following the method for manufacturing the stator 1.

Once the stator 1 is obtained (by the first or the second example of the manufacturing method), the stator casing 200 can also be formed by fixing the stator 1 obtained in the bottom wall 204 of the base 202. This fixing is, for example, done by bonding.

In a variant, the steps of each of the two examples of the method can be carried out directly at the same time as the positioning in the base 202 of the stator casing 200.

1. Method for manufacturing a stator for an axial-flux electric machine, said stator comprising a stator body, a plurality of teeth and at least one coil formed of an electrically conductive wire, each tooth being formed of a first part and a second part, the method comprising steps of:
providing a support part, in which the teeth are each positioned in a precise attitude,
forming an envelope of electrically insulating material intended to surround the second part of each tooth,
winding the electrically conductive wire around said envelope, and
fixing an end of the second part of each tooth to a face of the stator body.

2. The method according to claim 1, also comprising steps of:
prior to the formation of the support part, positioning of the teeth in preformed notches of a mold for manufacturing the support part, and
prior to the winding of the electrically conductive wire around said envelope, extraction of the teeth from the mold.

3. The method according to claim 2, wherein the support part and said envelope are formed of one single part by molding.

4. The method according to claim 1, wherein the support part having a plurality of openings, a step of putting each tooth in place in a corresponding opening of the support part is provided, each opening being shaped to receive each tooth in said precise attitude.

5. The method according to claim 4, wherein each tooth is fixed by bonding to the support part.

6. The method according to claim 1, wherein the support part and said envelope are formed of polymer material.

7. The method according to claim 1, wherein the fixing of the end of the second part of each tooth on the face of the stator body is done by bonding.

8. Stator for an axial-flux electric machine obtained by the manufacturing method according to claim 1.

9. Stator casing comprising the stator according to claim 8 and a base receiving the stator, said base comprising a bottom wall and side walls so as to form a cooling chamber.

10. The stator casing according to claim 9, wherein a polymer material is overmolded around the stator in the cooling chamber.

11. Engine comprising a rotor and the stator according to claim 8.

12. Automotive vehicle comprising the engine according to claim 9.
